(19) United States
(12) Patent Application Publication
(10) Pub. No.: US 2025/0074314 A1
(43) Pub. Date: Mar. 6, 2025

(54) Powered Vehicle Step Device

(71) Applicant: Roy Murray Barr, III, Glen Allan, MS (US)

(72) Inventor: Roy Murray Barr, III, Glen Allan, MS (US)

(21) Appl. No.: 18/596,878

(22) Filed: Mar. 6, 2024

Related U.S. Application Data
(60) Provisional application No. 63/580,480, filed on Sep. 5, 2023.

(51) Int. Cl. B60R 3/02

(52) U.S. Cl. CPC B60R 3/02

(57) ABSTRACT

A powered vehicle step device is provided. The device is comprised of a powered vehicle step device. The device may be comprised of a vehicle having a bumper comprised of at least one extendable step. The step can be extended to allow the user to stand on the step in an elevation position while working on the engine compartment of the vehicle.

### CROSS-REFERENCE TO RELATED APPLICATION

The present application claims priority to, and the benefit of, U.S. Provisional Application No. 63/580,480, which was filed on Sep. 5, 2023, and is incorporated herein by reference in its entirety.

### FIELD OF THE INVENTION

The present invention relates generally to the field of vehicle steps. More specifically, the present invention relates to a powered vehicle step device that provides an extendable step that extends from a vehicle and allows a user to stand on the step to access the engine compartment of said vehicle. Accordingly, the present disclosure makes specific reference thereto. Nonetheless, it is to be appreciated that aspects of the present invention are also equally applicable to other like applications, devices, and methods of manufacture.

### BACKGROUND

Working under the front hood of an elevated vehicle, such as, but not limited to, a truck, presents a unique set of challenges regarding the accessibility and safety of the vehicle's engine bay. Individuals often find themselves in need of a small ladder or stool to reach the interior areas of the engine. However, this can lead to dangerous situations as relying on makeshift stools or unsteady items to stand on increases the risk of accidents, such as slips and falls. These objects may also not provide the necessary stability or height required for the task. In some cases, individuals may attempt to stand on the front bumper of the vehicle to access the engine bay. While this might seem like a convenient solution, it usually does not offer enough space or support for the individual which makes it difficult to maintain the leverage and balance needed to effectively work inside the front hood area. This can lead to potentially unsafe working conditions or inadequate repair work.

Therefore, there exists a long-felt need in the art for a device that allows a user to access the engine bay of an elevated vehicle such as, but not limited to, a truck. There also exists a long-felt need in the art for a powered vehicle step device. Further, there exists a long-felt need in the art for a powered vehicle step device that provides a step that a user can stand on while comfortably and safely accessing the engine bay of an elevated vehicle. More specifically, there exists a long-felt need in the art for a powered vehicle step device that provides a step that a user can stand on while comfortably and safely accessing the engine bay of an elevated vehicle wherein the step is integrated into the vehicle itself.

The subject matter disclosed and claimed herein, in one embodiment thereof, comprises a powered vehicle step device. The device is comprised of a powered vehicle step device. The device may be comprised of a vehicle having a bumper comprised of at least one extendable step. The step can be extended to allow the user to stand on the step in an elevation position while working on the engine compartment of the vehicle.

In this manner, the powered vehicle step device of the present invention accomplishes all the foregoing objectives and provides a device that allows a user to access the engine bay of an elevated vehicle such as, but not limited to, a truck via a step that a user can stand on while comfortably and safely accessing the engine bay of an elevated vehicle. More specifically, the step is integrated into the vehicle itself for convenience.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a powered vehicle step device that provides at least one step that extends from the front surface of a vehicle bumper. In one embodiment, the device is comprised of a vehicle that is comprised of at least one bumper (front and/or rear) that is comprised of at least one step that can be extended from and retracted into the bumper via at least one motorized assembly.

When not in use, at least one step resides within an opening of the bumper. The step is comprised of at least one exterior facia that preferably matches the color, material, and finish of the bumper and/or vehicle. This conceals the step when retracted within the opening and gives the bumper a uniform appearance.

The step is attached to at least one motorized assembly within the opening. The assembly allows the step to be extended outwards from and retracted into the opening. In one embodiment, the assembly may also allow the step to be raised/lowered after being extended from the opening. The motorized assembly may be, but is not limited to, a motorized track, a motorized arm, a motorized hinge, a hydraulic arm, a hydraulic hinge, a hydraulic track, etc.

The assembly can be activated to extend and retract the step from the bumper via at least one button that may be pushed or kicked by the user. In one embodiment, the button is located on the exterior facia. In another embodiment, the button is located on the bumper. In a further embodiment, the button may be located anywhere on the vehicle exterior or in the vehicle interior. In an embodiment wherein the step can also raise/lower, the button may control the height of the step. In other embodiments, the step can be extended/retracted via at least one motion sensor.

The present invention is also comprised of a method of using the device. First, a device is provided comprised of a vehicle comprised of a bumper, the bumper comprised of at least one opening that receives at least one motorized assembly, at least one step that attaches to the motorized assembly, and at least one button. Then, a user can press the button to extend the step from the opening (and in one embodiment, raise the height of the step). Next, a user can step on the top surface of the step while working on/accessing the engine bay of the vehicle. Then, a user can step off of the step. Finally, a user can press the button to retract the step into the opening (and in one embodiment, lower the height of the step before doing so).

The present invention is also comprised of a second method of using the device. First, a device is provided comprised of a vehicle comprised of a bumper, the bumper comprised of at least one opening that receives at least one motorized assembly, at least one step that attaches to the motorized assembly, and at least one motion sensor. Then, a user can move in front of the sensor to activate the sensor to extend the step from the opening. Next, a user can step on the top surface of the step while working on/accessing the engine bay of the vehicle. Then, a user can step off of the step. Finally, a user can move in front of the sensor to retract the step into the opening.

Accordingly, the powered vehicle step device of the present invention is particularly advantageous as it provides a device that allows a user to access the engine bay of an elevated vehicle such as, but not limited to, a truck via a step that a user can stand on while comfortably and safely accessing the engine bay of an elevated vehicle. More specifically, the step is integrated into the vehicle itself for convenience. In this manner, the powered vehicle step device overcomes the limitations of existing devices and methods known in the art that are used to access the engine bay of a vehicle.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a powered vehicle step device of the present invention wherein the step is extended from the bumper of a vehicle in accordance with the disclosed architecture;

FIG. 2 illustrates a perspective view of one potential embodiment of a powered vehicle step device of the present invention wherein the step is extended from the bumper of a vehicle while a user is standing on the step in accordance with the disclosed architecture;

FIG. 3 illustrates a perspective view of one potential embodiment of a powered vehicle step device of the present invention wherein the step is retracted within the bumper of a vehicle in accordance with the disclosed architecture;

FIG. 4 illustrates a flowchart of a method of using one potential embodiment of a powered vehicle step device of the present invention in accordance with the disclosed architecture; and

FIG. 5 illustrates a flowchart of a method of using one potential embodiment of a powered vehicle step device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a user to access the engine bay of an elevated vehicle such as, but not limited to, a truck. There also exists a long-felt need in the art for a powered vehicle step device. Further, there exists a long-felt need in the art for a powered vehicle step device that provides a step that a user can stand on while comfortably and safely accessing the engine bay of an elevated vehicle. More specifically, there exists a long-felt need in the art for a powered vehicle step device that provides a step that a user can stand on while comfortably and safely accessing the engine bay of an elevated vehicle wherein the step is integrated into the vehicle itself.

The present invention, in one exemplary embodiment, is comprised of a powered vehicle step device. During use, the device provides at least one step that extends from the front surface of a vehicle bumper. In one embodiment, the device is comprised of a vehicle that is comprised of at least one bumper (front and/or rear) that is comprised of at least one step that can be extended from and retracted into the bumper via at least one motorized assembly. When not in use, at least one step resides within an opening of the bumper. The step is comprised of at least one exterior facia that preferably matches the color, material, and finish of the bumper and/or vehicle that conceals the step when retracted within the opening and gives the bumper a uniform appearance.

The step is attached to at least one motorized assembly within the opening. The assembly allows the step to be extended outwards from and retracted into the opening. In one embodiment, the assembly may also allow the step to be raised/lowered after being extended from the opening. The motorized assembly may be, but is not limited to, a motorized track, a motorized arm, a motorized hinge, a hydraulic arm, a hydraulic hinge, a hydraulic track, etc.

The assembly can be activated to extend and retract the step from the bumper via at least one button that may be pushed or kicked by the user. In one embodiment, the button is located on the exterior facia. In another embodiment, the button is located on the bumper. In a further embodiment, the button may be located anywhere on the vehicle exterior or in the vehicle interior. In an embodiment wherein the step can also raise/lower, the button may control the height of the step. In other embodiments, the step can be extended/retracted via at least one motion sensor.

The present invention is also comprised of a method of using the device. First, a device is provided comprised of a vehicle comprised of a bumper, the bumper comprised of at least one opening that receives at least one motorized assembly, at least one step that attaches to the motorized assembly, and at least one button. Then, a user can press the button to extend the step from the opening (and in one embodiment, raise the height of the step). Next, a user can step on the top surface of the step while working on/accessing the engine bay of the vehicle. Then, a user can step off of the step. Finally, a user can press the button to retract the step into the opening (and in one embodiment, lower the height of the step before doing so).

The present invention is also comprised of a second method of using the device. First, a device is provided comprised of a vehicle comprised of a bumper, the bumper comprised of at least one opening that receives at least one motorized assembly, at least one step that attaches to the motorized assembly, and at least one motion sensor. Then, a user can move in front of the sensor to activate the sensor to extend the step from the opening. Next, a user can step on the top surface of the step while working on/accessing the engine bay of the vehicle. Then, a user can step off of the step. Finally, a user can move in front of the sensor to retract the step into the opening.

Accordingly, the powered vehicle step device of the present invention is particularly advantageous as it provides a device that allows a user to access the engine bay of an elevated vehicle such as, but not limited to, a truck via a step that a user can stand on while comfortably and safely accessing the engine bay of an elevated vehicle. More specifically, the step is integrated into the vehicle itself for convenience. In this manner, the powered vehicle step device overcomes the limitations of existing devices and methods known in the art that are used to access the engine bay of a vehicle.

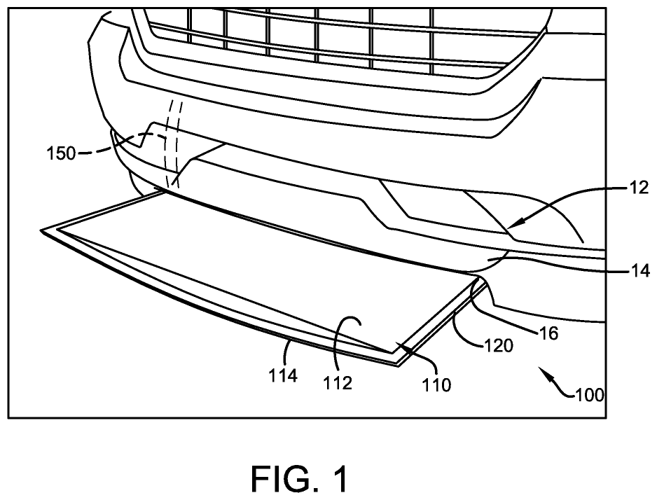

Referring initially to the drawings, FIG. 1 illustrates a perspective view of one potential embodiment of a powered vehicle step device 100 of the present invention wherein the step 110 is extended from the bumper 12 of a vehicle 10 in accordance with the disclosed architecture. The device 100 provides at least one step 110 that extends from the front surface 14 of a vehicle 10 bumper 12. In one embodiment, the device 100 is comprised of a vehicle 10 (of any type/style) that is comprised of at least one bumper 12 (front and/or rear) that is comprised of at least one step 110 that can be extended from and retracted into the bumper 12 via at least one motorized assembly 120. In another embodiment, the device 100 is comprised of at least one bumper 12 (front and/or rear) that is comprised of at least one step 110 that can be extended from and retracted into the bumper 12 via at least one motorized assembly 120 that can be retrofitted onto any type of existing vehicle 10. In a further embodiment, the device 100 is comprised of at least one step 110 that can be extended from and retracted into the bumper 12 via at least one motorized assembly 120 that can be retrofitted onto any type of existing bumper 12 (front or rear).

In the preferred embodiment, the device 100 is comprised of a vehicle 10 such as, but not limited to, a truck. The vehicle 10 is comprised of at least one bumper 12 that may be the front and/or rear bumper. The bumper 12 is comprised of a front surface 14 (or in another embodiment, any surface of the bumper 12) comprised of at least one opening 16.

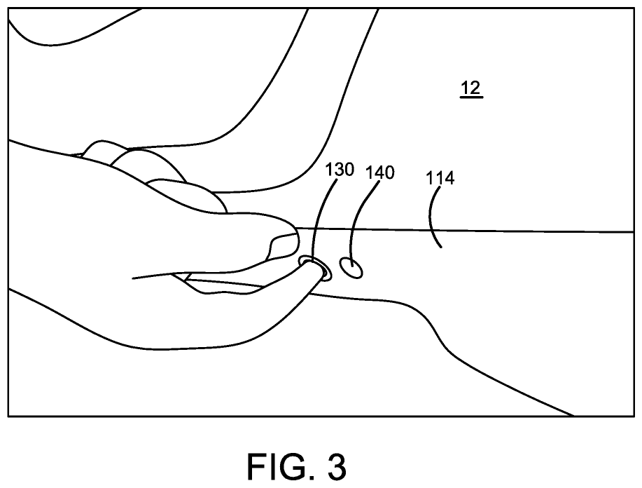

When not in use, at least one step 110 resides within the opening 16, as seen in FIG. 3. The step 110 is comprised of at least one exterior facia 114 that preferably matches the color, material, and finish of the bumper 12 and/or vehicle 10. This conceals the step 110 when retracted within the opening 16 and gives the bumper 12 a uniform appearance.

The step 110 is attached to at least one motorized assembly 120 within the opening 16. The assembly 120 allows the step 110 to be extended outwards from and retracted into the opening 16. In one embodiment, the assembly 120 may also allow the step 110 to be raised/lowered after being extended from the opening 16. The motorized assembly 120 may be, but is not limited to, a motorized track, a motorized arm, a motorized hinge, a hydraulic arm, a hydraulic hinge, a hydraulic track, etc.

The assembly 120 can be activated to extend and retract the step 110 from the bumper 12 via at least one button 130 that may be pushed or kicked by the user. In one embodiment, the button 130 is located on the exterior facia 114. In another embodiment, the button 130 is located on the bumper 12. In a further embodiment, the button 130 may be located anywhere on the vehicle 10 exterior 18 or in the vehicle 10 interior 20. In an embodiment wherein the step 110 can also raise/lower, the button 130 may control the height of the step 110. In another embodiment, the step 110 can be extended/retracted via at least one motion sensor 140. It should be appreciated that the device 100 may have both the button 130 and sensor 140 or either the button 130 or sensor 140, wherein one or both controls the height or extension/retraction of the step 110.

The step 110 may be any size and shape in different embodiments. In one embodiment, the step 110 is comprised of a tiered step. In another embodiment, the step 110 is comprised of a flat step. The top surface 112 of the step 110 is preferably comprised of a non-slip material such as, but not limited to, non-slip rubber. The top surface 112 may also be comprised of a raised or recessed texture for further grip.

The assembly 120 preferably receives power from the existing power supply of the vehicle 10 via at least one wire 150.

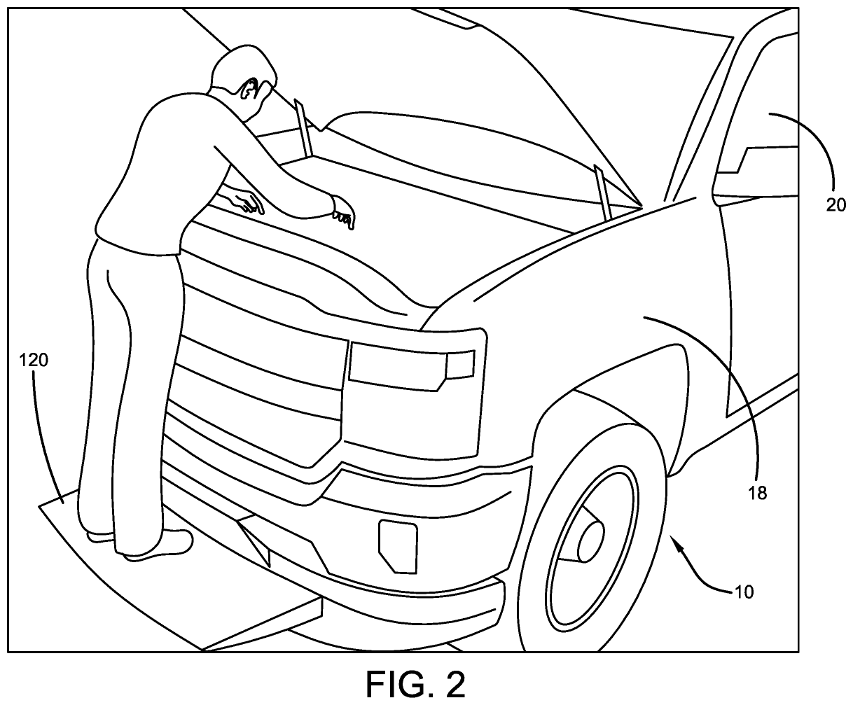

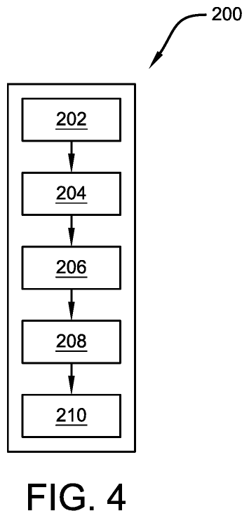

The present invention is also comprised of a method of using 200 the device 100, as seen in FIG. 4. First, a device 100 is provided comprised of a vehicle 10 comprised of a bumper, the bumper 12 comprised of at least one opening 16 that receives at least one motorized assembly 120, at least one step 110 that attaches to the motorized assembly 120, and at least one button 130 [Step 202]. Then, a user can press the button 130 to extend the step from 110 from the opening 16 (and in one embodiment, raise the height of the step 110) [Step 204]. Next, a user can step on the top surface 112 of the step 110 while working on/accessing the engine bay of the vehicle 10, as seen in FIG. 2 [Step 206]. Then, a user can step off of the step 110 [Step 208]. Finally, a user can press the button 130 to retract the step 110 into the opening 16 (and in one embodiment, lower the height of the step 110 before doing so) [Step 210].

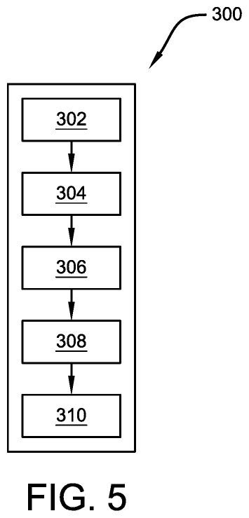

The present invention is also comprised of a second method of using 300 the device 100, as seen in FIG. 5. First, a device 100 is provided comprised of a vehicle 10 comprised of a bumper, the bumper 12 comprised of at least one opening 16 that receives at least one motorized assembly 120, at least one step 110 that attaches to the motorized assembly 120, and at least one motion sensor 140 [Step 302]. Then, a user can move in front of the sensor 140 to activate the sensor 140 to extend the step from 110 from the opening 16 [Step 304]. Next, a user can step on the top surface 112 of the step 110 while working on/accessing the engine bay of the vehicle 10 [Step 306]. Then, a user can step off of the step 110 [Step 308]. Finally, a user can move in front of the sensor 140 to retract the step 110 into the opening 16 [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “powered vehicle step device” and “device” are interchangeable and refer to the powered vehicle step device 100 of the present invention.

Notwithstanding the foregoing, the powered vehicle step device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the powered vehicle step device 100 as shown in the FIGS. are for illustrative purposes only, and that many other sizes and shapes of the powered vehicle step device 100 are well within the scope of the present disclosure. Although the dimensions of the powered vehicle step device 100 are important design parameters for user convenience, the powered vehicle step device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A powered vehicle step device comprising:
a vehicle comprised of a bumper, the bumper comprised of an opening;
a motorized assembly positioned within the opening;
a step attached to the motorized assembly; and
a button.

2. The powered vehicle step device of claim 1, wherein the vehicle is comprised of a truck.

3. The powered vehicle step device of claim 1, wherein the bumper is comprised of a front bumper or a rear bumper.

4. The powered vehicle step device of claim 1, wherein the button controls the extension and the retraction of the step from the opening via motorized assembly.

5. The powered vehicle step device of claim 1 further comprised of a motion sensor.

6. The powered vehicle step device of claim 5, wherein the motion sensor controls the extension and the retraction of the step from the opening via motorized assembly.

7. The powered vehicle step device of claim 1, wherein the step is comprised of an exterior facia.

8. The powered vehicle step device of claim 7, wherein the exterior facia matches a color, a material, or a finish of the bumper or the vehicle.

9. The powered vehicle step device of claim 1, wherein the motorized assembly is comprised of a motorized track, a motorized arm, a motorized hinge, a hydraulic arm, a hydraulic hinge, or a hydraulic track.

10. A powered vehicle step device comprising:
a bumper, the bumper comprised of an opening;
a motorized assembly positioned within the opening;
a step attached to the motorized assembly;
a button; and
a wire.

11. The powered vehicle step device of claim 10, wherein the bumper is comprised of a front bumper.

12. The powered vehicle step device of claim 10, wherein the bumper is comprised of a rear bumper.

13. The powered vehicle step device of claim 10, wherein the button controls the extension and the retraction of the step from the opening via motorized assembly.

14. The powered vehicle step device of claim 10 further comprised of a motion sensor.

15. The powered vehicle step device of claim 14, wherein the motion sensor controls the extension and the retraction of the step from the opening via motorized assembly.

16. The powered vehicle step device of claim 10, wherein the step is comprised of an exterior facia.

17. The powered vehicle step device of claim 16, wherein the exterior facia matches a color, a material, or a finish of the bumper.

18. The powered vehicle step device of claim 10, wherein the motorized assembly is comprised of a motorized track, a motorized arm, a motorized hinge, a hydraulic arm, a hydraulic hinge, or a hydraulic track.

19. The powered vehicle step device of claim 10, wherein the step is comprised of a non-slip rubber top surface.

20. A method of using a powered vehicle step device, the method comprising the following steps:
providing a powered vehicle step device comprised of a vehicle comprised of a bumper, the bumper comprised of an opening 16 that receives a motorized assembly, a step that attaches to the motorized assembly, and a button;
pressing the button to extend the step from the opening;
stepping on a top surface of the step;
stepping off of the step; and
pressing the button to retract the step into the opening.
